(19) United States
(12) Patent Application Publication
(10) Pub. No.: US 2025/0095279 A1
(43) Pub. Date: Mar. 20, 2025

(54) SYSTEMS AND METHODS FOR CONVERTING VIDEO FOOTAGE INTO POINT CLOUDS

(71) Applicant: Djinn Technologies Ltd., London (GB)

(72) Inventors: Jean-Brunel WEBB-BENJAMIN, Nuneaton (GB); Bryan Dunphy, Dublin (IE); Brett Greene, Boston, MA (US)

(73) Assignee: Djinn Technologies Ltd., London (GB)

(21) Appl. No.: 18/889,034

(22) Filed: Sep. 18, 2024

Related U.S. Application Data
(60) Provisional application No. 63/539,215, filed on Sep. 19, 2023.

(51) Int. Cl. G06T 15/08; G06T 7/11; G06T 19/20

(52) U.S. Cl. CPC G06T 15/08; G06T 7/11; G06T 19/20; G06T 2200/24; G06T 2207/10016; G06T 2207/20104; G06T 2207/30232; G06T 2210/56; G06T 2219/2004; G06T 2219/2016

(57) ABSTRACT

The disclosed systems and methods relate to a system and method for generating a virtual marker for a volumetric camera system can include receiving a selection of an object in a video feed within a monitored environment; placing the selected object into a three-dimensional volume; segmenting the volume to remove data unrelated to the selected object; dividing the selected object into one or more sub-objects until a second volume with a size smaller than a pre-defined value is generated; and generating the second volume as a first virtual marker.

### CROSS-REFERENCE TO RELATED APPLICATIONS

This application claims priority to U.S. Provisional Application No. 63/539,215, filed Sep. 19, 2023, which is herein incorporated by reference in its entirety.

### BACKGROUND OF THE DISCLOSURE

Industries such as construction, robotics, medicine, production and virtual reality increasingly need faster, more efficient sensors for rapid and precise workflow and productivity. However, traditional approaches for converting video footage to three-dimensional images and/or point clouds generally make use of separate, external markers (i.e., ArUco markers) that can be applied to an object or positioned within the scanned environment to provide an established time and a fixed point in space. In addition, sensors used in these systems are generally synchronized in pairs, and those pairs are synchronized with other matching pairs to form new compounded synced sensor pairs. However, these processes are both time-consuming and inefficient.

### SUMMARY OF THE DISCLOSURE

According to one aspect of the present disclosure, a method for generating a virtual marker for a volumetric camera system can include receiving a selection of an object in a video feed within a monitored environment; placing the selected object into a three-dimensional volume; segmenting the volume to remove data unrelated to the selected object; dividing the selected object into one or more sub-objects until a second volume with a size smaller than a pre-defined value is generated; and generating the second volume as a first virtual marker.

In some embodiments, the method can include sub-dividing the one or more sub-objects until the second volume with a size smaller than the pre-defined value is generated. In some embodiments, receiving the selection of an object can include receiving a selection via a user interface of a user device that selects the object in the video feed playing on the user device. In some embodiments, the method can include receiving a selection of a second object in the video feed within the monitored environment; placing the second selected object into the three-dimensional volume; segmenting the volume to remove data unrelated to the second selected object; dividing the second selected object into one or more second sub-objects until a third volume with a size smaller than the pre-defined value is generated; and generating the third volume as a second virtual marker.

In some embodiments, the method can include stitching a point cloud using the first and second virtual markers. In some embodiments, dividing the selected object into one or more sub-objects can include accessing one or more additional video feeds of the object; identifying the object within the one or more additional video feeds; and dividing the selected object within the one or more additional video feeds into the one or more sub-objects until a fourth volume with a size smaller than the pre-defined value is generated; and generating the fourth volume as a third virtual marker. In some embodiments, the method can include receiving a selection of a second object in the one or more additional feeds within the monitored environment; placing the second selected object of the one or more additional feeds into the three-dimensional volume; segmenting the volume to remove data unrelated to the second selected object of the one or more additional feeds; dividing the second selected object of the one or more additional feeds into one or more second sub-objects until a fifth volume with a size smaller than the pre-defined value is generated; and generating the fifth volume as a fourth virtual marker. In some embodiments, the method can include stitching a second point cloud using the third and fourth virtual markers. In some embodiments, the method can include combining the first and second point clouds to form a third point cloud.

In some embodiments, the method can include accessing a second point cloud generated by a paired sensor; and employing a rotation and a translation on the point cloud relative to the second point cloud.

According to another aspect of the present disclosure, a computing system can include a processor and a non-transitory computer-readable storage device storing computer-executable instructions, the instructions when executed by the processor cause the processor to perform operations. The operations can include receiving a selection of an object in a video feed within a monitored environment; placing the selected object into a three-dimensional volume; segmenting the volume to remove data unrelated to the selected object; dividing the selected object into one or more sub-objects until a second volume with a size smaller than a pre-defined value is generated; and generating the second volume as a first virtual marker.

In some embodiments, the operations can include sub-dividing the one or more sub-objects until the second volume with a size smaller than the pre-defined value is generated. In some embodiments, receiving the selection of an object can include receiving a selection via a user interface of a user device that selects the object in the video feed playing on the user device. In some embodiments, the operations can include receiving a selection of a second object in the video feed within the monitored environment; placing the second selected object into the three-dimensional volume; segmenting the volume to remove data unrelated to the second selected object; dividing the second selected object into one or more second sub-objects until a third volume with a size smaller than the pre-defined value is generated; and generating the third volume as a second virtual marker.

In some embodiments, the operations can include stitching a point cloud using the first and second virtual markers. In some embodiments, dividing the selected object into one or more sub-objects can include accessing one or more additional video feeds of the object; identifying the object within the one or more additional video feeds; and dividing the selected object within the one or more additional video feeds into the one or more sub-objects until a fourth volume with a size smaller than the pre-defined value is generated; and generating the fourth volume as a third virtual marker. In some embodiments, the operations can include receiving a selection of a second object in the one or more additional feeds within the monitored environment; placing the second selected object of the one or more additional feeds into the three-dimensional volume; segmenting the volume to remove data unrelated to the second selected object of the one or more additional feeds; dividing the second selected object of the one or more additional feeds into one or more second sub-objects until a fifth volume with a size smaller than the pre-defined value is generated; and generating the fifth volume as a fourth virtual marker. In some embodiments, the operations can include stitching a second point cloud using the third and fourth virtual markers. In some embodiments, the operations can include combining the first and second point clouds to form a third point cloud.

In some embodiments, the operations can include accessing a second point cloud generated by a paired sensor; and employing a rotation and a translation on the point cloud relative to the second point cloud.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

The drawings are not necessarily to scale, or inclusive of all elements of a system, emphasis instead generally being placed upon illustrating the concepts, structures, and techniques sought to be protected herein.

FIG. 1 is a block diagram of an example volumetric camera system according to some embodiments of the present disclosure.

FIG. 2 is another block diagram of an example volumetric camera system according to some embodiments of the present disclosure.

FIG. 3 is an example camera device and host for use within the systems of FIGS. 1 and 2 according to some embodiments of the present disclosure.

FIG. 4 is an example method for detecting a fall that can be performed within the systems of FIGS. 1 and 2 according to some embodiments of the present disclosure.

FIG. 5 is an example synchronization method that can be performed within the systems of FIGS. 1 and 2 according to some embodiments of the present disclosure.

FIG. 6 shows an example flow for three-dimensional object detection according to some embodiments of the present disclosure.

FIG. 7 shows example configurations for recording a live performance according to some embodiments of the present disclosure.

FIG. 8 is an example synchronization architecture according to some embodiments of the present disclosure.

FIG. 9 is an example configuration for stereoscopic depth mapping of biological samples according to some embodiments of the present disclosure.

FIGS. 10-13 are example user interfaces that can be displayed within the systems of FIGS. 1 and 2 according to some embodiments of the present disclosure.

FIG. 14 is an example user interface flow for use within the systems of FIGS. 1 and 2 according to some embodiments of the present disclosure.

FIG. 15 is an example method for generating a virtual marker according to some embodiments of the present disclosure.

FIG. 16 is an example method for generating a three-dimensional point cloud of an object according to some embodiments of the present disclosure.

FIG. 17 is an example server device that can be used within the system of FIG. 2 according to an embodiment of the present disclosure.

FIG. 18 is an example computing device that can be used within the system of FIG. 2 according to an embodiment of the present disclosure.

### DESCRIPTION

The following detailed description is merely exemplary in nature and is not intended to limit the invention or the applications of its use.

Embodiments of the present disclosure relate to systems and methods for providing intelligent, real-time, marker-less synchronization, alignment, tracking, and projection technology for volumetric camera systems. In some embodiments, the disclosed systems are provided for converting video footage into point clouds. In particular, the disclosed techniques allow for three-dimensional images and point clouds to be generated from captured video without separate, discrete, external markers that would typically be required in the scanned environment. Such techniques can offer significant computational and temporal savings during conversions. The disclosed systems and methods can enable a user to select an object (in some cases, a segmented object) from a camera feed, which is then defined as a virtual marker. The system can then automatically identify the same object (or segmented object) from multiple camera angles and reduce it, via certain dividing and sub-dividing techniques, to a size small enough to function as a marker. From here, the disclosed system can utilize the marker (and other markers generated in a similar way) to stitch together three-dimensional point clouds. For example, various cameras may monitor/record camera footage of an object in an environment. Each camera can generate a point cloud that represents the object as viewed from the angle of the associated camera. Then, each point cloud can be stitched together to form a more accurate and all-encompassing three-dimensional point cloud defining the object. Therefore, the disclosed system can consolidate scanning, capturing, and streaming in one platform, making the system faster, more accurate, and computationally cheaper.

The disclosed systems and methods can also employ audio analysis. For example, the system can combine visual identification of objects from camera feeds, light detection and ranging (LIDAR) point clouds, and sound location/reverberation to improve identification accuracy.

In addition, the disclosed systems and methods can provide real-time video analysis using wearable devices. For example, the wearable device can utilize video cameras and use a combination of facial expression detection, gait-movement detection, hand-object detection, human object detection, and human object distance detection to identify potential threats to a monitored user. In some embodiments, the disclosed device can provide audio and/or haptic feedback to the monitored user to alert them to any identified threats/issues. The device can make use of existing trained datasets (i.e., gait, physiognomy, weapons, etc.) to determine potential threats. For example, a combination of identified physiognomy (anger) and gait (threatening) can be used to alert a monitored user of a potentially threatening individual in his or her vicinity.

The disclosed techniques can have a wide range of applications, including, but not limited to, military and medical applications, as well as other scanning applications, such as virtual production, industry robotics, and construction. Other applications can include forgery detection that combines 0.01 mm resolution surface scan data derived used the disclosed embodiments and a large language model (LLM) trained on object surface and chemical/structural architecture data. For example, this can be useful in the validation of diamonds and other stones and objects, such as fashion bags, sneakers, etc.

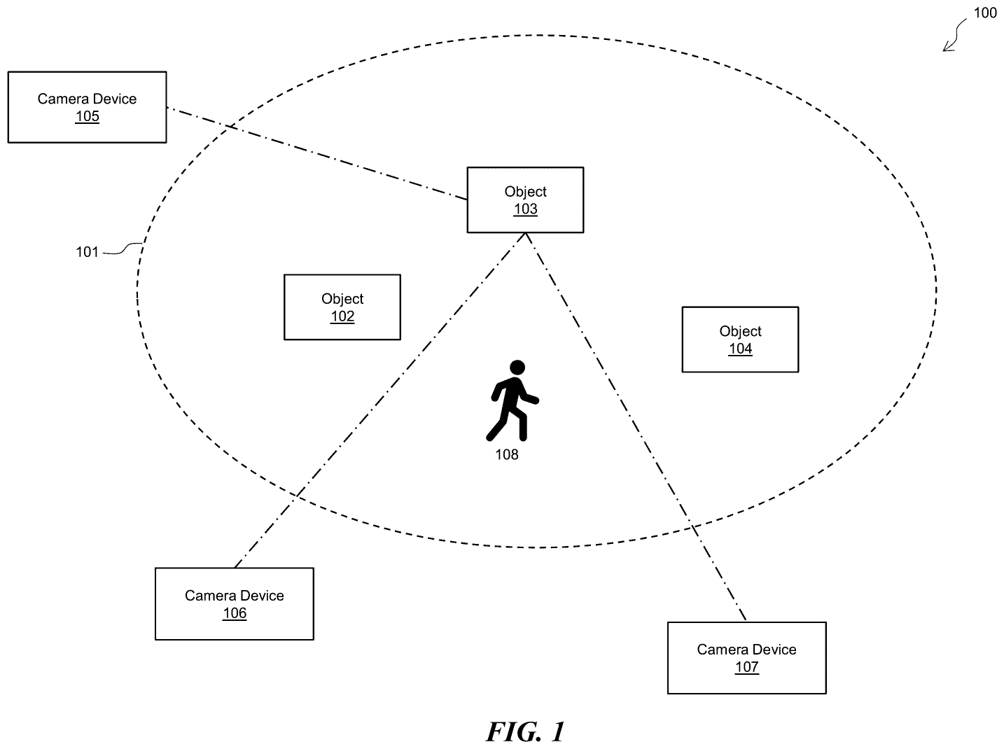

FIG. 1 is a block diagram of an example volumetric camera system 100 according to some embodiments of the present disclosure. The system 100 can be configured to monitor, record, capture, etc. objects within an environment 101, such as objects 102-104 or a person 108. In some embodiments, the environment 101 can be a medical environment, a military environment, a virtual production environment (i.e., for a video game), and many others. The system 100 can include camera devices 105-107, and each can be configured to capture and record, for example, object 103. In addition, although three camera devices are shown in FIG. 1, the system 100 is not limited to this number.

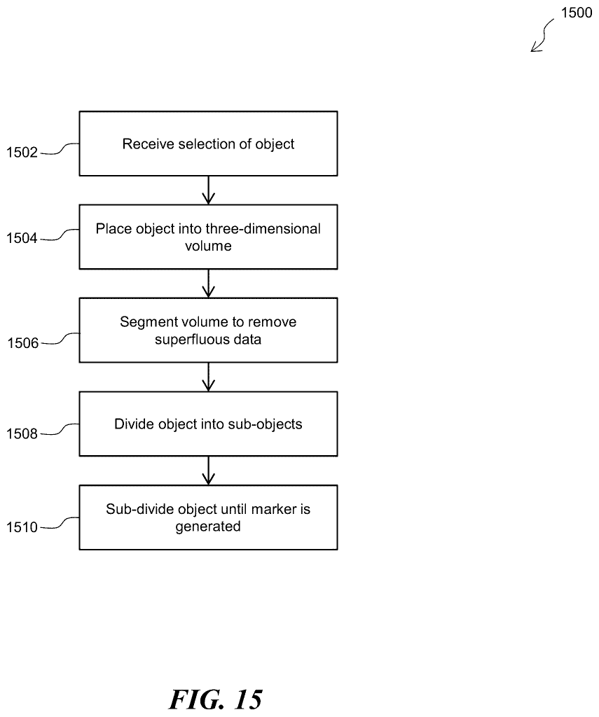

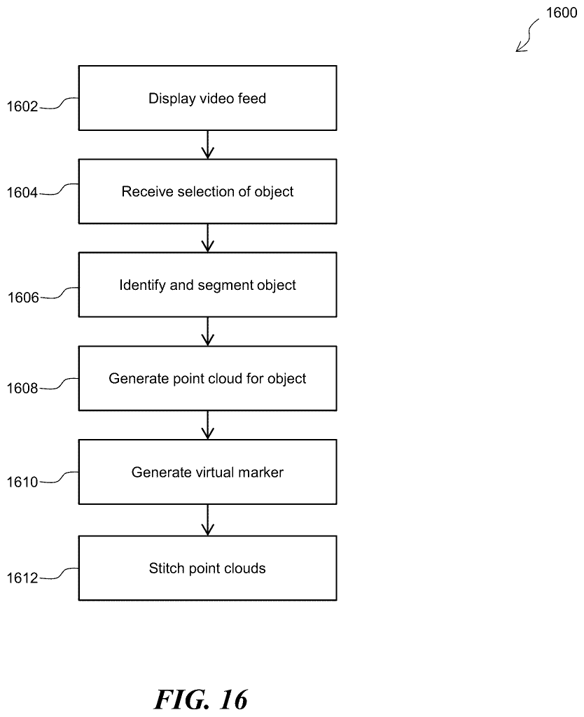

In some embodiments, each of the cameras 105-107 can include an OAK-D camera or other similar camera applicable for computer and robotic vision systems. In addition, each of the cameras 105-107 can include functionality to perform neural and other AI processing and generate three-dimensional point clouds for an object. In some embodiments, each of the cameras 105-107 can capture both video images and LIDAR data. Then, the cameras 105-107 can be configured to perform various computational tasks on the captured data to generate virtual markers (see FIGS. 15 and 16). In some embodiments, each of the cameras 105-107 can include a chip that enables segmentation and three-dimensional pose estimation to be performed by its own hardware (rather than by software). This can offer savings in computational processing power.

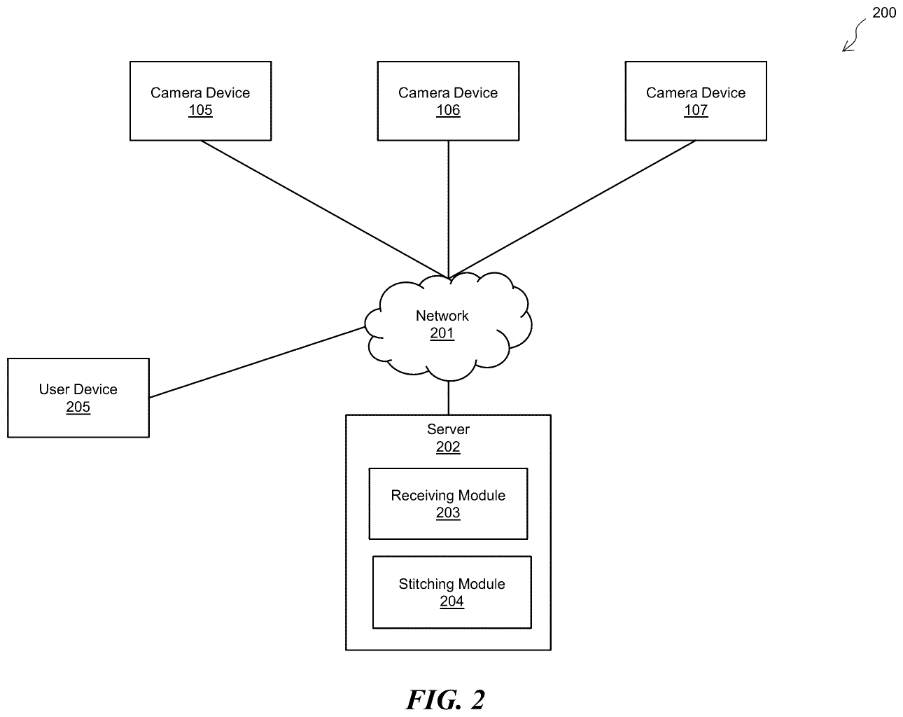

FIG. 2 is another block diagram of an example volumetric camera system 200 according to some embodiments of the present disclosure. The system 200 can include various camera devices 105-17 that are communicably coupled to a server 202 via network 201. In some embodiments, the server 202 can alternatively take the form of various types of devices that can perform the computational techniques described herein. For example, the techniques can be run locally on a computing device, remotely, online via an Internet or mobile connection, and/or via a server/client distributed model, such as for connected studio/facility deployments. In addition, a user device 205 can be communicably coupled to the server 202. The server 202 can include a receiving module 203 and a stitching module 204. In some embodiments, the receiving module 203 can be configured to receive data/feeds captured from the camera devices 105-107 and the stitching module 204 can be configured to perform stitching techniques on the received feeds. For example, the stitching module 204 can combine the various three-dimensional point clouds received from the camera devices 105-107 to generate a combined point cloud or a “stitched” point cloud. In addition, the stitching module 204 can perform various synchronization techniques (see FIG. 5) in real-time and in an autonomous manner. For example, the stitching module 204 can employ a rotation and translation for each received point cloud relative to a point cloud from a paired sensor. Moreover, the stitching module 204 can ensure frames from the camera devices 105-107 are locked in sync by creating a frame queue that delays one by a frame if there is a delay by more than a pre-defined value, such as 33 milliseconds.

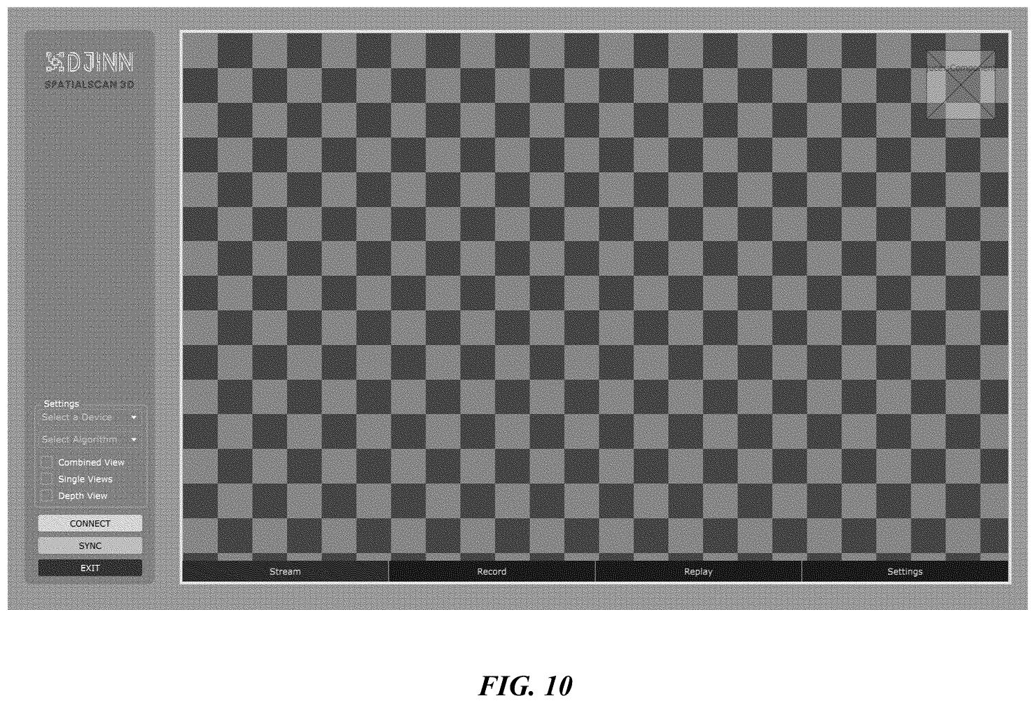

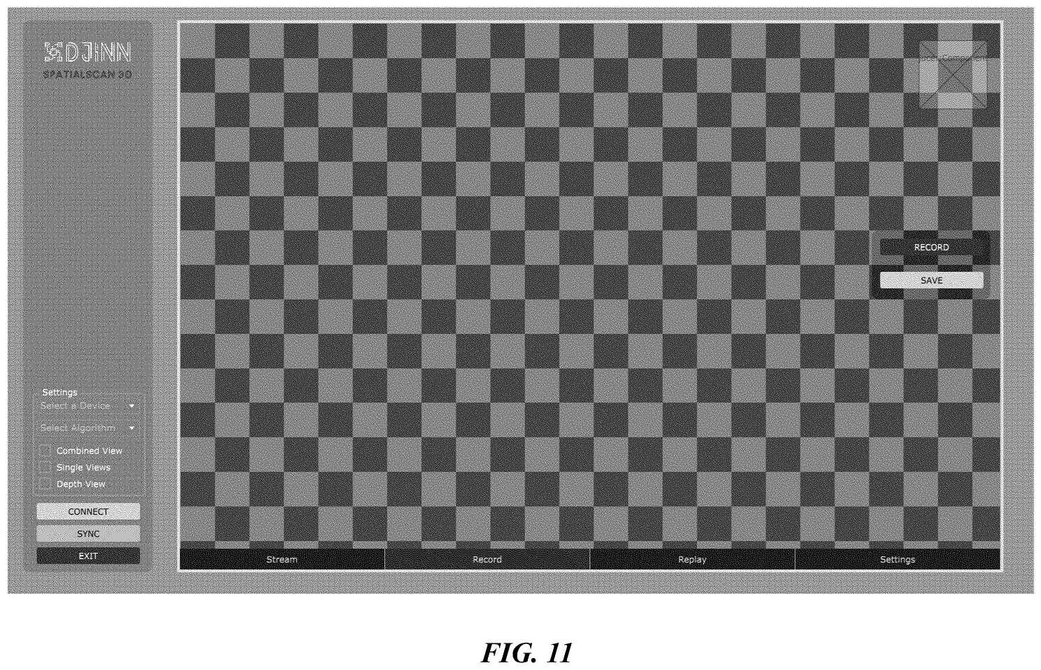

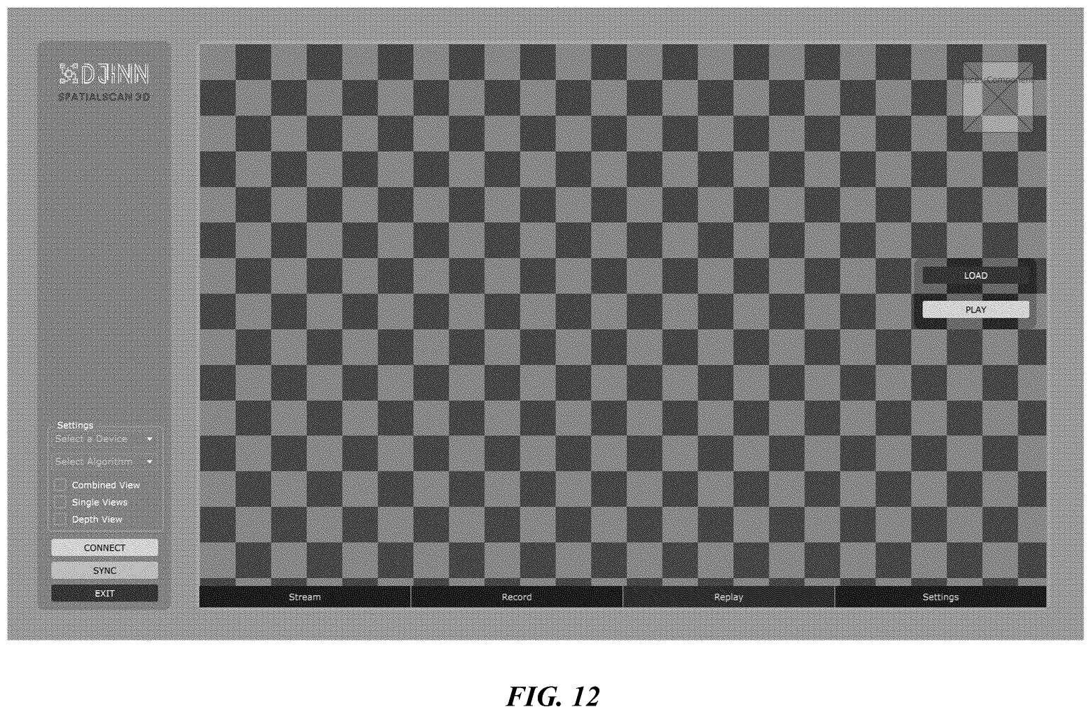

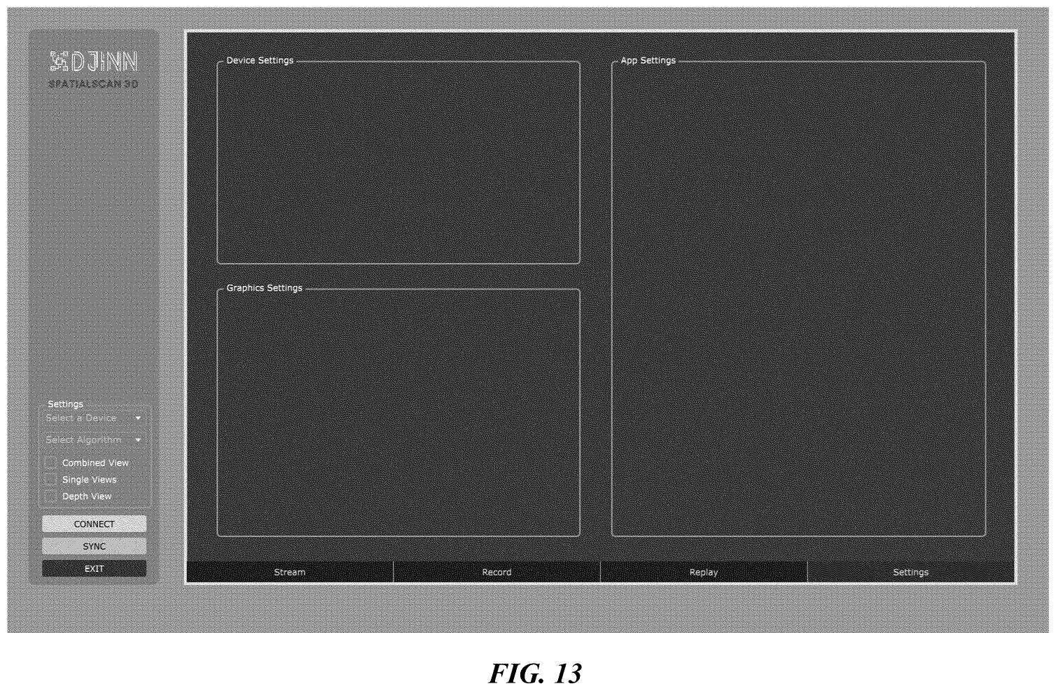

In some embodiments, the user device 205 can be used by a user to access displays of the feeds captured by the camera devices 105-107, as well as make selections of objects that should be monitored. In addition, the user interfaces described in FIGS. 10-13 can be displayed on the user device 205.

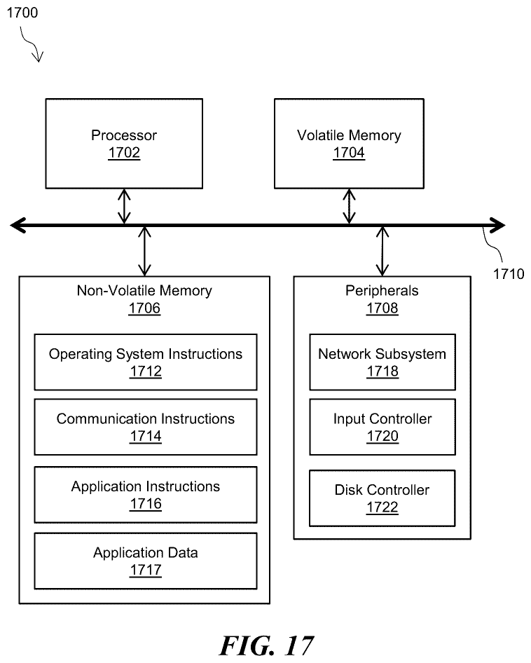

A user device 205 can include one or more computing devices capable of receiving user input, transmitting and/or receiving data via the network 201, and or communicating with the server 202. In some embodiments, a user device 205 can be a conventional computer system, such as a desktop or laptop computer. Alternatively, a user device 205 can be a device having computer functionality, such as a personal digital assistant (PDA), a mobile telephone, a smartphone, or other suitable device. In some embodiments, a user device 205 can be the same as or similar to the computing device 1700 described below with respect to FIG. 17.

The network 201 can include one or more wide areas networks (WANs), metropolitan area networks (MANs), local area networks (LANs), personal area networks (PANs), or any combination of these networks. The network 201 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 201 can also use standard communication technologies and/or protocols.

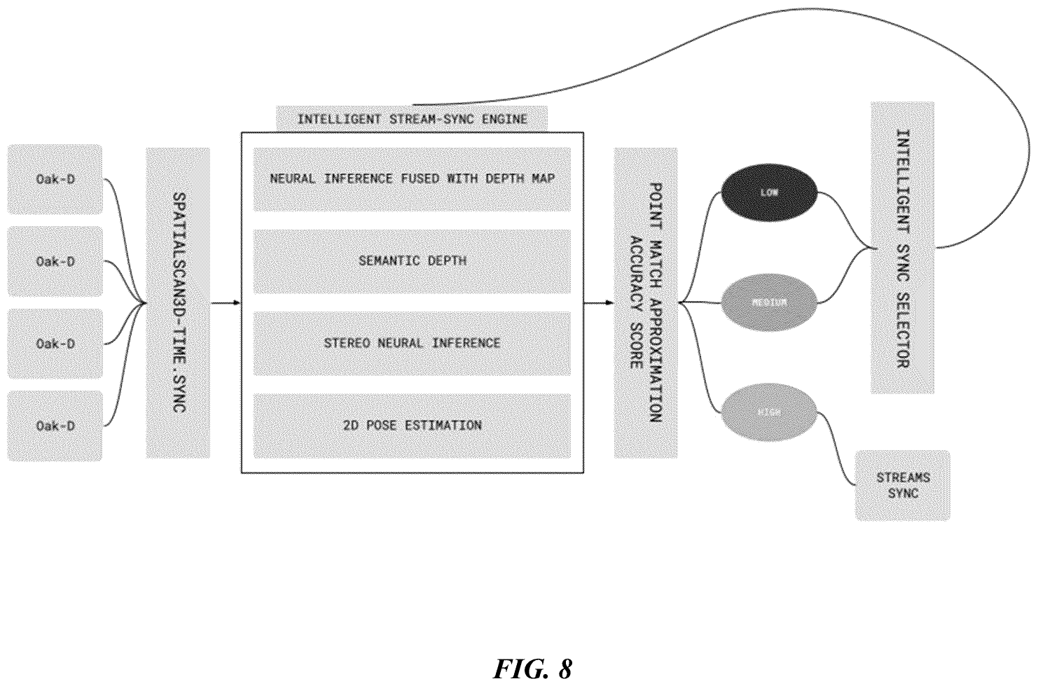

The server 202 may include any combination of one or more of web servers, mainframe computers, general-purpose computers, personal computers, or other types of computing devices. The server 202 may represent distributed servers that are remotely located and communicate over a communications network, or over a dedicated network such as a local area network (LAN). The server 202 may also include one or more back-end servers for carrying out one or more aspects of the present disclosure. In some embodiments, the server 202 may be the same as or similar to server 1800 described below in the context of FIG. 8.

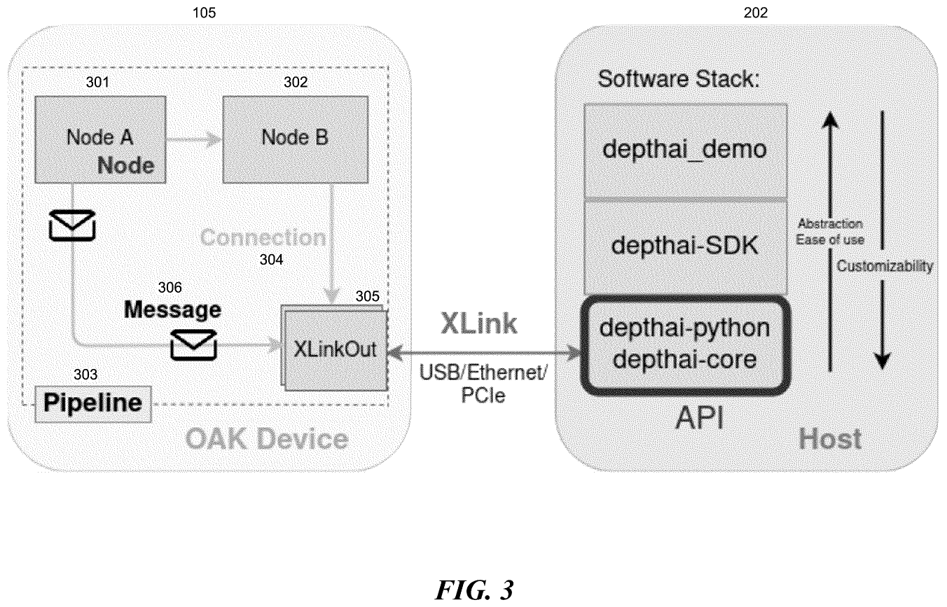

FIG. 3 is an example camera device and host for use within the systems of FIGS. 1 and 2 according to some embodiments of the present disclosure. For example, the camera device can be the camera device 105-107. The camera device 105 can be connected, such as via a USB/Ethernet/PCIe connection, to a host, which can be server 202. The camera device 105 can include nodes 301 and 301, which can each be single functionalities of DepthAI. Each node 301 and 302 can have inputs and/or outputs with configurable properties, such as the resolution of the camera. The camera device 105 can also include a pipeline 303 which is a complete workflow on the device 105 comprising nodes and connections between them. In addition, the camera device 105 can include a connection 304 that is a link between one node's output and another one's input. In order to define the pipeline 303 dataflow, the connections 304 can define where to send messages in order to achieve an expected result. The camera device 105 can also include an XLinkOut 305, which can include a middleware that can be capable of exchanging data between a device 105 and host 202. XLinkIn node allows sending the data from the host to a device, while XLinkOut does the opposite. Finally, messages 206 can be transferred between the nodes 301 and 302, as defined by the connection 304.

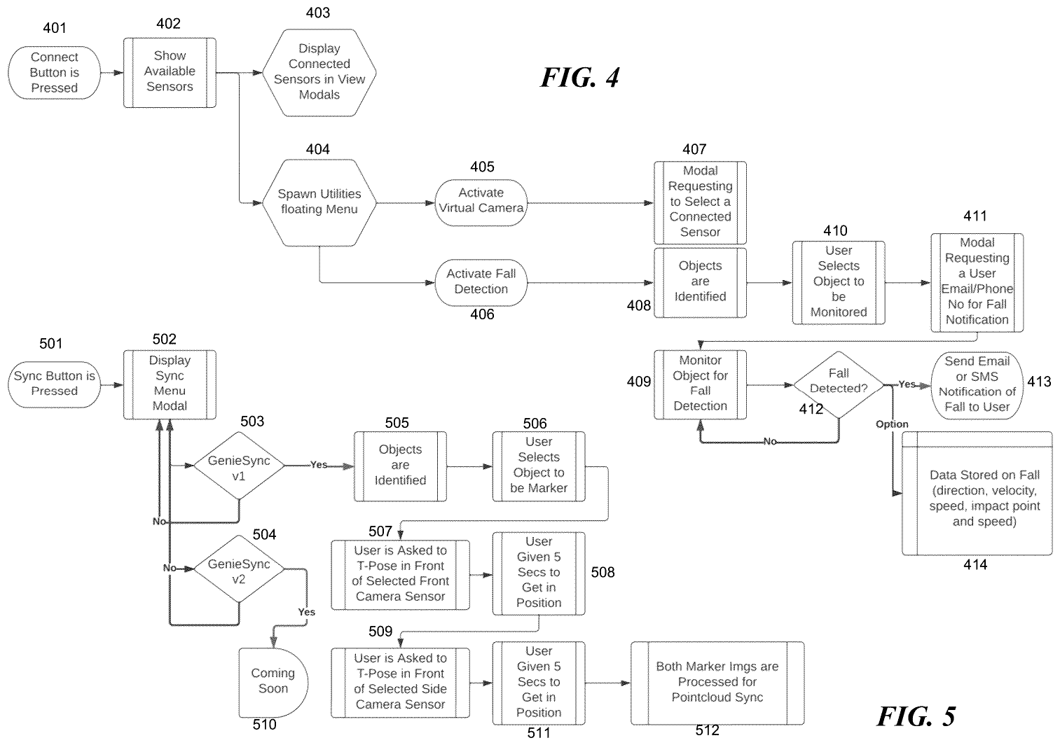

FIG. 4 is an example method for detecting a fall that can be performed within the systems of FIGS. 1 and 2 according to some embodiments of the present disclosure. At block 401, a connect button is pressed, such as via the user device 205. At block 402, available sensors (i.e., camera devices 105-107) are shown on the user device 205 to the user. At block 402, the user device 205 can display connected sensors in view modals and/or, at block 404, can spawn a utilities floating menu. At block 405, a virtual camera is activated and, at block 406, a fall detection functionality is activated. At block 407, after the virtual camera is activated, a model is requested to selected a connected sensor. At block 408, after the fall detection functionality is activated, objects (i.e., objects 102-104) are identified within the environment 101 by the camera devices 105-107. At block 410, a user, via the user device 205, selects object(s) to be monitored and, at block 411, a modal requests a user email/phone number for notification of a detected fall. At block 409, the camera devices 105-107 monitor the object for a fall. At block 412, if a fall is not detected, monitoring is continued. Alternatively, if a fall is detected, a notification (e.g., email or SMS message) is transmitted to the user. In some embodiments, at block 414, fall data can be stored, such as direction, velocity, speed, and impact point.

FIG. 5 is an example synchronization method that can be performed within the systems of FIGS. 1 and 2 according to some embodiments of the present disclosure. In some embodiments, the synchronization method can be performed in real-time and in an autonomous manner during operation. At block 501, a sync button is pressed, such as via the user device 205. At block 502, the user device 205 syncs a menu modal and a sync method begins at 503. At block 505, the cameras 105-107 identify objects in a monitored environment 101. At block 506, a user, via the user device 205, selects object(s) to be monitored. At block 507, the user is asked (via the user device 205) to T-Pose in front of the selected camera device. At block 508, the user is given, for example, five seconds to get into the position. At block 509, the user is asked (via the user device 205) to T-Pose in front of a second selected camera device. At block 511, the user is given, for example, five seconds to get in position. At block 512, the virtual markers from the selected camera devices are processed for pointcloud synchronization.

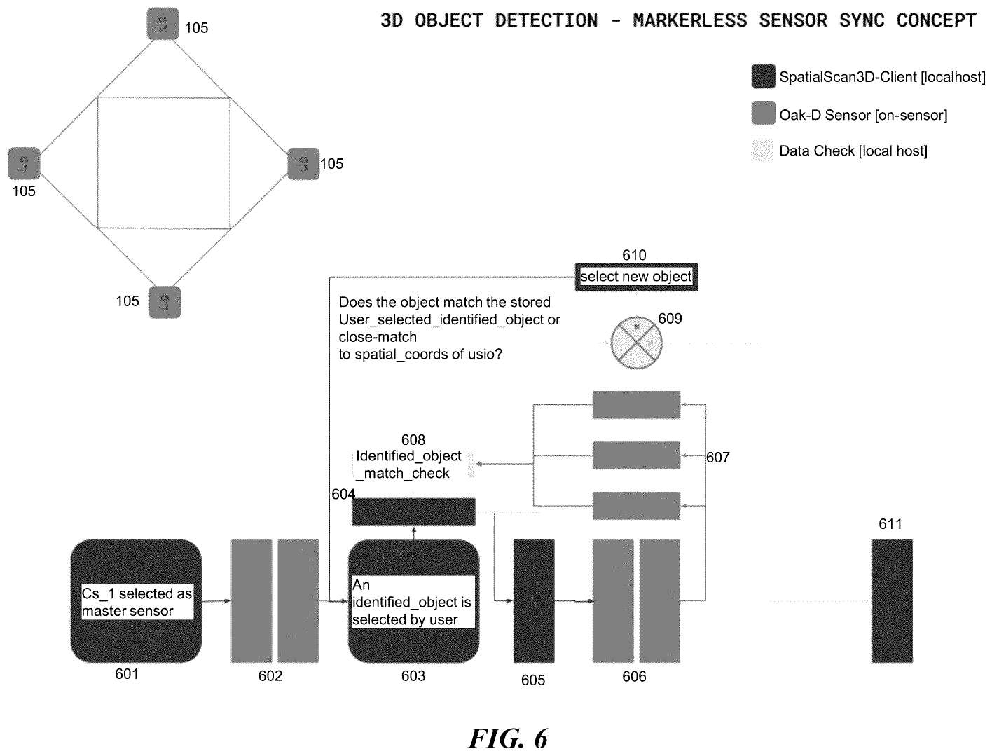

FIG. 6 shows an example flow for three-dimensional object detection according to some embodiments of the present disclosure. For example, the flow in FIG. 6 describes a process similar to the process of FIG. 5 and illustrates which components perform the defined steps.

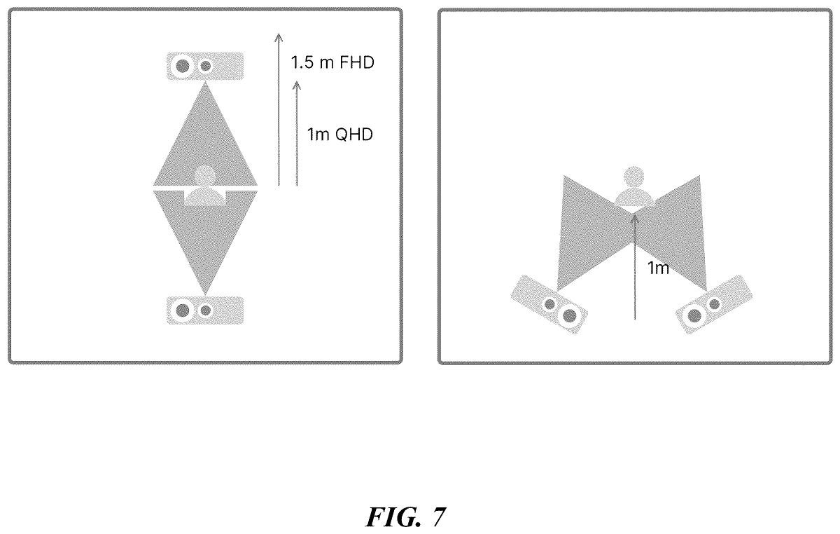

FIG. 7 shows example configurations for recording a live performance according to some embodiments of the present disclosure. On the left, camera devices are placed both in front of and behind the recording artists. Each can be configured to focus on movements that extend the arms away from the body so as to reduce object interocclusion. On the right, camera devices are placed an extended and slightly wrapped view, providing edges and sides.

FIG. 8 is an example synchronization architecture according to some embodiments of the present disclosure. Similar to as described in relation to FIG. 5, the architecture can be used in real-time and in an autonomous manner. For example, four camera devices can capture and record data of an object within a monitored environment, which is transmitted to an engine (e.g., server 202) for synchronization techniques. The synchronization engine (i.e., stitching module 204) can perform a neural inference fused with a depth map, a semantic depth analysis, a stereo neural inference, and two-dimensional pose estimation on the object. Then, a point match approximation accuracy score is performed. If the score is “high,” the stream can be synced. If the score is not high (i.e., medium or low), the processes can be repeated.

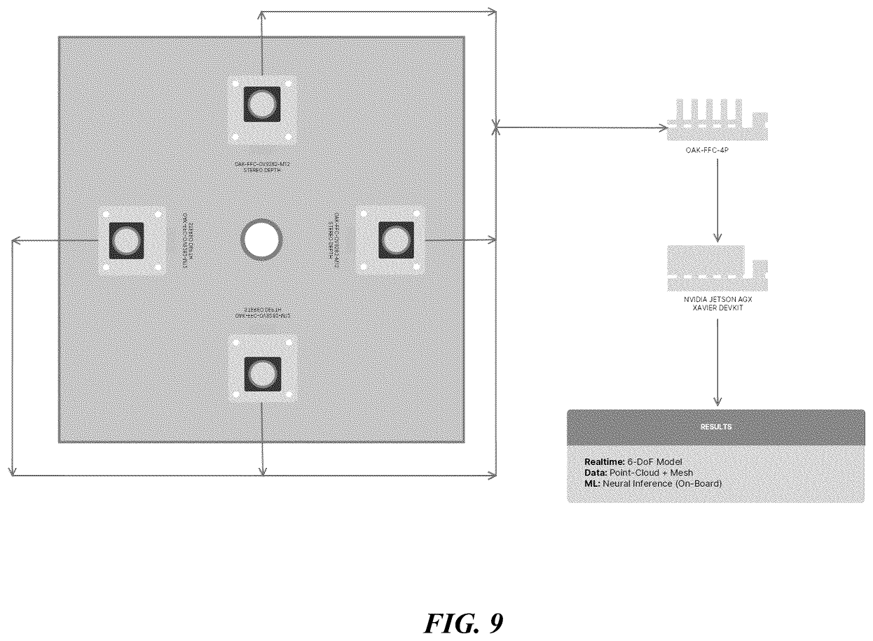

FIG. 9 is an example configuration for stereoscopic depth mapping of biological samples according to some embodiments of the present disclosure. Here, four camera devices are used to monitor a live biological sample. The sensors can be hydrophobically coated and deployed in-vitro around the sample and can be connected by ribbon cables. This can allow for immediate processing of the streams for sync and stitching together.

FIGS. 10-13 are example user interfaces that can be displayed within the systems of FIGS. 1 and 2 according to some embodiments of the present disclosure.

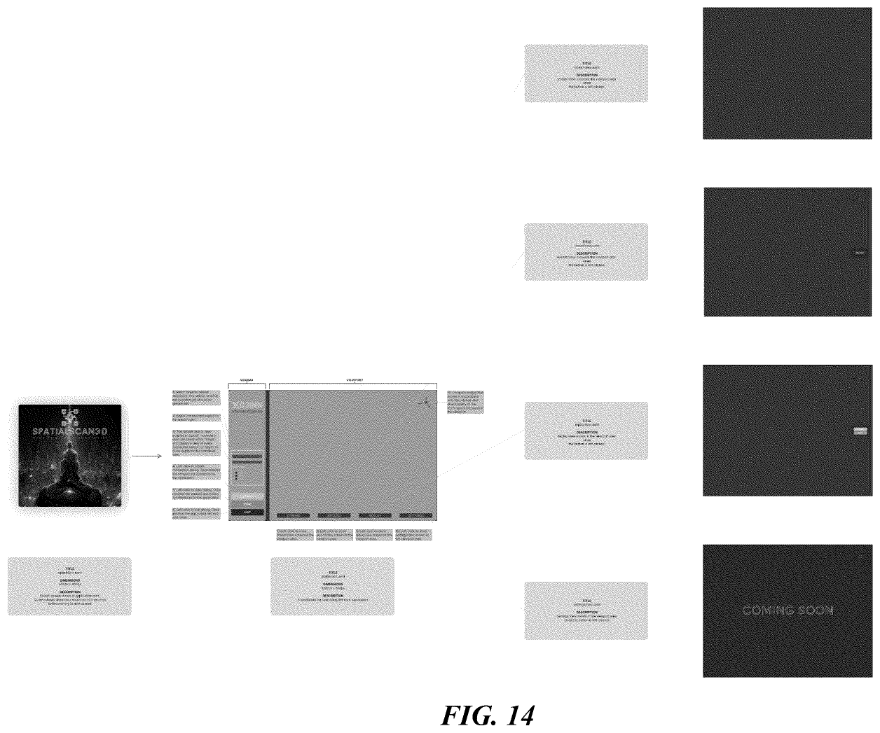

FIG. 14 is an example user interface flow for use within the systems of FIGS. 1 and 2 according to some embodiments of the present disclosure. The main user interface can include a sidebar, which is a panel that comprises the core controls for the entire application. They can include a sensors section with a sensor dropdown selection; a sync algorithm with a sync algorithm dropdown section that includes object detection, post estimation, and stereo neural inference; a sensor views section that includes combination, single, and depth; and an app controls button section that includes a connect button, a sync button, and an exit button. In addition, the user interface can include a viewport section that is a panel which comprises the view and menu controls for the entire application. The viewport components can include stream, record, reply, settings, and a compass.

FIG. 15 is an example method 1500 for generating a virtual marker according to some embodiments of the present disclosure. In some embodiments, the method 1500 can be performed by one or more of the camera devices 105-107. At block 1502, the camera device 105 receives a selection of an object, such as via a user on user device 205. At block 1504, the camera device 105 places the object into a three-dimensional volume. At block 1506, the camera device 105 segments the volume to remove superfluous data. At block 1508, the camera device 105 divides the selected object into sub-objects. For example, in the case of a person being the object, the camera device 105 can divide the object into arms, hands, fingers, etc. At block 1510, the camera device 105 continues to sub-divide the object until a volume is identified that is small enough to act as a virtual marker. These virtual markers can then be used by the system (i.e., the server 202 or alternative computing system) to stitch together the three-dimensional point clouds generated by each camera device 105-107.

FIG. 16 is an example method 1600 for generating a three-dimensional point cloud of an object according to some embodiments of the present disclosure. At block 1602, the user device 205 displays a video feed from camera devices 105-107 to a user. At block 1604, the user device 205 receives a selection of an object by the user. At block 1606, each of the camera devices 105-107 identify and segment the selected object from different angles. At block 1608, each of the camera devices 105-107 generates a point cloud for the selected object. At block 1610, each of the camera devices 105-107 generates a virtual marker for the object. At block 1612, the stitching module 204 stitches the point clouds together. A synchronization technique can also be performed.

FIG. 17 is a diagram of an example server device 1700 that can be used within system 200 of FIG. 2. Server device 1700 can implement various features and processes as described herein. Server device 1700 can be implemented on any electronic device that runs software applications derived from complied instructions, including without limitation personal computers, servers, smart phones, media players, electronic tablets, game consoles, email devices, etc. In some implementations, server device 1700 can include one or more processors 1702, volatile memory 1704, non-volatile memory 1706, and one or more peripherals 1708. These components can be interconnected by one or more computer buses 1710.

Processor(s) 1702 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 1710 can be any known internal or external bus technology, including but not limited to ISA, EISA, PCI, PCI Express, USB, Serial ATA, or FireWire. Volatile memory 1704 can include, for example, SDRAM. Processor 1702 can receive instructions and data from a read-only memory or a random access memory or both. Essential elements of a computer can include a processor for executing instructions and one or more memories for storing instructions and data.

Non-volatile memory 1706 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 1706 can store various computer instructions including operating system instructions 1712, communication instructions 1714, application instructions 1716, and application data 1717. Operating system instructions 1712 can include instructions for implementing an operating system (e.g., Mac OS®, Windows®, or Linux). The operating system can be multi-user, multiprocessing, multitasking, multithreading, real-time, and the like. Communication instructions 1714 can include network communications instructions, for example, software for implementing communication protocols, such as TCP/IP, HTTP, Ethernet, telephony, etc. Application instructions 1716 can include instructions for various applications. Application data 1717 can include data corresponding to the applications.

Peripherals 1708 can be included within server device 1700 or operatively coupled to communicate with server device 1700. Peripherals 1708 can include, for example, network subsystem 1718, input controller 1720, and disk controller 1722. Network subsystem 1718 can include, for example, an Ethernet of WiFi adapter. Input controller 1720 can be any known input device technology, including but not limited to a keyboard (including a virtual keyboard), mouse, track ball, and touch-sensitive pad or display. Disk controller 1722 can include one or more mass storage devices for storing data files; such devices include magnetic disks, such as internal hard disks and removable disks; magneto-optical disks; and optical disks.

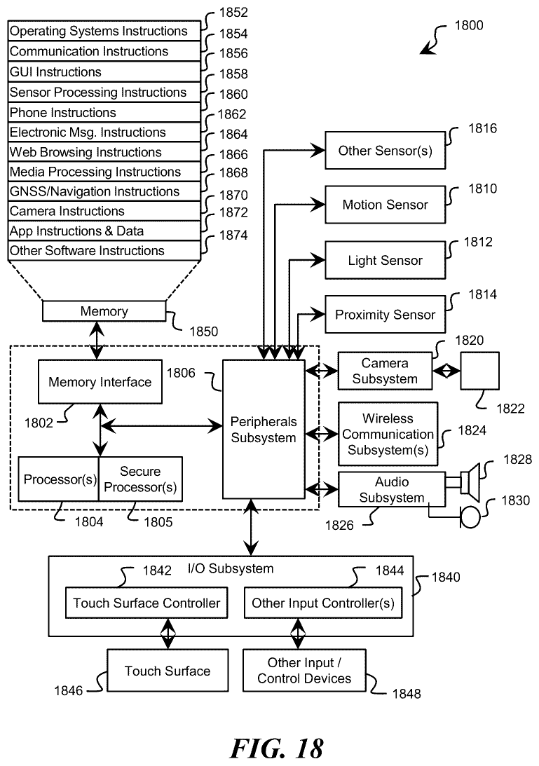

FIG. 18 is an example computing device that can be used within the system 200 of FIG. 2, according to an embodiment of the present disclosure. In some embodiments, device 700 can be user device 205. The illustrative user device 1800 can include a memory interface 1802, one or more data processors, image processors, central processing units 1804, and or secure processing units 1805, and peripherals subsystem 1806. Memory interface 1802, one or more central processing units 1804 and or secure processing units 1805, and or peripherals subsystem 1806 can be separate components or can be integrated in one or more integrated circuits. The various components in user device 1800 can be coupled by one or more communication buses or signal lines.

Sensors, devices, and subsystems can be coupled to peripherals subsystem 1806 to facilitate multiple functionalities. For example, motion sensor 1810, light sensor 1812, and proximity sensor 1814 can be coupled to peripherals subsystem 1806 to facilitate orientation, lighting, and proximity functions. Other sensors 1816 can also be connected to peripherals subsystem 1806, such as a global navigation satellite system (GNSS) (e.g., GPS receiver), a temperature sensor, a biometric sensor, magnetometer, or other sensing device, to facilitate related functionalities.

Camera subsystem 1820 and optical sensor 1822, e.g., a charged coupled device (CCD) or a complementary metal-oxide semiconductor (CMOS) optical sensor, can be utilized to facilitate camera functions, such as recording photographs and video clips. Camera subsystem 1820 and optical sensor 1822 can be used to collect images of a user to be used during authentication of a user, e.g., by performing facial recognition analysis.

Communication functions can be facilitated through one or more wired and or wireless communication subsystems 1824, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 1824. The specific design and implementation of communication subsystems 1824 can depend on the communication network(s) over which the user device 1800 is intended to operate. For example, user device 1800 can include communication subsystems 1824 designed to operate over a GSM network, a GPRS network, an EDGE network, a WiFi or WiMax network, and a Bluetooth™ network. For example, wireless communication subsystems 1824 can include hosting protocols such that device 1800 can be configured as a base station for other wireless devices and or to provide a WiFi service.

Audio subsystem 1826 can be coupled to speaker 1828 and microphone 1830 to facilitate voice-enabled functions, such as speaker recognition, voice replication, digital recording, and telephony functions. Audio subsystem 1826 can be configured to facilitate processing voice commands, voice-printing, and voice authentication, for example.

I/O subsystem 1840 can include a touch-surface controller 1842 and or other input controller(s) 1844. Touch-surface controller 1842 can be coupled to a touch-surface 1846. Touch-surface 1846 and touch-surface controller 1842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 1846.

The other input controller(s) 1844 can be coupled to other input/control devices 1848, such as one or more buttons, rocker switches, thumb-wheel, infrared port, USB port, and or a pointer device such as a stylus. The one or more buttons (not shown) can include an up/down button for volume control of speaker 1828 and or microphone 1830.

In some implementations, a pressing of the button for a first duration can disengage a lock of touch-surface 1846; and a pressing of the button for a second duration that is longer than the first duration can turn power to user device 1800 on or off. Pressing the button for a third duration can activate a voice control, or voice command, module that enables the user to speak commands into microphone 1830 to cause the device to execute the spoken command. The user can customize a functionality of one or more of the buttons. Touch-surface 1846 can, for example, also be used to implement virtual or soft buttons and or a keyboard.

In some implementations, user device 1800 can present recorded audio and or video files, such as MP3, AAC, and MPEG files. In some implementations, user device 1800 can include the functionality of an MP3 player, such as an iPod™. User device 1800 can, therefore, include a 36-pin connector and or 8-pin connector that is compatible with the iPod. Other input/output and control devices can also be used.

Memory interface 1802 can be coupled to memory 1850. Memory 1850 can include high-speed random access memory and or non-volatile memory, such as one or more magnetic disk storage devices, one or more optical storage devices, and or flash memory (e.g., NAND, NOR). Memory 1850 can store an operating system 1852, such as Darwin, RTXC, LINUX, UNIX, OS X, Windows, or an embedded operating system such as VxWorks.

Operating system 1852 can include instructions for handling basic system services and for performing hardware dependent tasks. In some implementations, operating system 1852 can be a kernel (e.g., UNIX kernel). In some implementations, operating system 1852 can include instructions for performing voice authentication.

Memory 1850 can also store communication instructions 1854 to facilitate communicating with one or more additional devices, one or more computers and or one or more servers. Memory 1850 can include graphical user interface instructions 1856 to facilitate graphic user interface processing; sensor processing instructions 1858 to facilitate sensor-related processing and functions; phone instructions 1860 to facilitate phone-related processes and functions; electronic messaging instructions 1862 to facilitate electronic messaging-related process and functions; web browsing instructions 1864 to facilitate web browsing-related processes and functions; media processing instructions 1866 to facilitate media processing-related functions and processes; GNSS/Navigation instructions 1868 to facilitate GNSS and navigation-related processes and instructions; and or camera instructions 1870 to facilitate camera-related processes and functions.

Memory 1850 can store application (or “app”) instructions and data 1872, such as instructions for the apps described in the above context. Memory 1850 can also store other software instructions 1874 for various other software applications in place on device 1800. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A method for generating a virtual marker for a volumetric camera system comprising:
receiving a selection of an object in a video feed within a monitored environment;
placing the selected object into a three-dimensional volume;
segmenting the volume to remove data unrelated to the selected object;
dividing the selected object into one or more sub-objects until a second volume with a size smaller than a pre-defined value is generated; and
generating the second volume as a first virtual marker.

2. The method of claim 1 comprising sub-dividing the one or more sub-objects until the second volume with a size smaller than the pre-defined value is generated.

3. The method of claim 1, wherein receiving the selection of an object comprises receiving a selection via a user interface of a user device that selects the object in the video feed playing on the user device.

4. The method of claim 1 comprising:
receiving a selection of a second object in the video feed within the monitored environment;
placing the second selected object into the three-dimensional volume;
segmenting the volume to remove data unrelated to the second selected object;
dividing the second selected object into one or more second sub-objects until a third volume with a size smaller than the pre-defined value is generated; and
generating the third volume as a second virtual marker.

5. The method of claim 4, comprising stitching a point cloud using the first and second virtual markers.

6. The method of claim 5, wherein dividing the selected object into one or more sub-objects comprises:
accessing one or more additional video feeds of the object;
identifying the object within the one or more additional video feeds; and
dividing the selected object within the one or more additional video feeds into the one or more sub-objects until a fourth volume with a size smaller than the pre-defined value is generated; and
generating the fourth volume as a third virtual marker.

7. The method of claim 6 comprising:
receiving a selection of a second object in the one or more additional feeds within the monitored environment;
placing the second selected object of the one or more additional feeds into the three-dimensional volume;
segmenting the volume to remove data unrelated to the second selected object of the one or more additional feeds;
dividing the second selected object of the one or more additional feeds into one or more second sub-objects until a fifth volume with a size smaller than the pre-defined value is generated; and
generating the fifth volume as a fourth virtual marker.

8. The method of claim 7 comprising stitching a second point cloud using the third and fourth virtual markers.

9. The method of claim 8 comprising combining the first and second point clouds to form a third point cloud.

10. The method of claim 5 comprising:
accessing a second point cloud generated by a paired sensor; and
employing a rotation and a translation on the point cloud relative to the second point cloud.

11. A computing system comprising:
a processor; and
a non-transitory computer-readable storage device storing computer-executable instructions, the instructions when executed by the processor cause the processor to perform operations comprising:
receiving a selection of an object in a video feed within a monitored environment;
placing the selected object into a three-dimensional volume;
segmenting the volume to remove data unrelated to the selected object;
dividing the selected object into one or more sub-objects until a second volume with a size smaller than a pre-defined value is generated; and
generating the second volume as a first virtual marker.

12. The computing system of claim 11 comprising sub-dividing the one or more sub-objects until the second volume with a size smaller than the pre-defined value is generated.

13. The computing system of claim 11, wherein receiving the selection of an object comprises receiving a selection via a user interface of a user device that selects the object in the video feed playing on the user device.

14. The computing system of claim 11 comprising:
receiving a selection of a second object in the video feed within the monitored environment;
placing the second selected object into the three-dimensional volume;
segmenting the volume to remove data unrelated to the second selected object;
dividing the second selected object into one or more second sub-objects until a third volume with a size smaller than the pre-defined value is generated; and
generating the third volume as a second virtual marker.

15. The computing system of claim 14, comprising stitching a point cloud using the first and second virtual markers.

16. The computing system of claim 15, wherein dividing the selected object into one or more sub-objects comprises:
accessing one or more additional video feeds of the object;
identifying the object within the one or more additional video feeds; and
dividing the selected object within the one or more additional video feeds into the one or more sub-objects until a fourth volume with a size smaller than the pre-defined value is generated; and
generating the fourth volume as a third virtual marker.

17. The computing system of claim 16 comprising:
receiving a selection of a second object in the one or more additional feeds within the monitored environment;
placing the second selected object of the one or more additional feeds into the three-dimensional volume;
segmenting the volume to remove data unrelated to the second selected object of the one or more additional feeds;
dividing the second selected object of the one or more additional feeds into one or more second sub-objects until a fifth volume with a size smaller than the pre-defined value is generated; and
generating the fifth volume as a fourth virtual marker.

18. The computing system of claim 17 comprising stitching a second point cloud using the third and fourth virtual markers.

19. The computing system of claim 18 comprising combining the first and second point clouds to form a third point cloud.

20. The computing system of claim 15 comprising:
accessing a second point cloud generated by a paired sensor; and
employing a rotation and a translation on the point cloud relative to the second point cloud.
